(19) United States
(12) Patent Application Publication
(10) Pub. No.: US 2011/0007170 A1
(43) Pub. Date: Jan. 13, 2011

(54) ACCESSORY DEVICE FOR A CAMERA

(75) Inventors: Timo AUTIO, Seinajoki (FI); Jussi-Pekka ALANKO, Tuomikyla (FI); Leif SNELLMAN, Eugmo (FI)

Correspondence Address: YOUNG & THOMPSON, 209 Madison Street, Suite 500, Alexandria, VA, 22314, US

(73) Assignee: OY CYBERNCAM TECHNOLOGY LTD, Tuomikyla (FI)

(21) Appl. No.: 12/833,304

(22) Filed: Jul. 9, 2010

(30) Foreign Application Priority Data
Jul. 9, 2009 (FI) U20090273

(51) Int. Cl. H04N 5/232

(52) U.S. Cl. 348/211.2; 348/E05.042

(57) ABSTRACT

A device for arranging a remote reading for a camera includes a data communication unit for transferring image data in a wireless way and a connecting element for connecting the device to the camera, such as a game or monitoring camera and for transferring image data from the camera device to the data communication unit. The connecting element is adapted to be connected to a memory slot of the camera device and the device is adapted to receive image data from the camera device via the connecting element connected to the memory slot.

### TECHNICAL FIELD OF THE INVENTION

The invention relates to accessory devices for cameras and especially to a device for remote reading cameras, such as game or monitoring cameras.

### BACKGROUND OF THE INVENTION

Prior art game cameras must be checked almost daily. One must drive by a car even tens of kilometers only just checking whether there are images in the game camera. Thus there is a need for developing game cameras so that images stored therein can be read remotely.

Different kinds of monitoring cameras have been developed for universal outdoor use comprising a transmitter for transmitting image data stored in the monitoring camera over a data communication network. Problems relating to these are that totally new equipment is needed and in addition that the monitoring cameras are not suit for a game monitoring.

### BRIEF DESCRIPTION OF THE INVENTION

Now an enhanced solution is developed especially for remote reading cameras.

According to an aspect of the invention a device is developed which can be connected to a camera, such as a game camera. The device comprises a data communication unit for transferring image data wirelessly and connecting means for connecting the device to the camera device, such as the game or monitoring camera, and for transferring image data from the camera device to the data communication unit. The connecting means are adapted to be connected to a memory slot of the camera device and the device is adapted to receive image data from the camera device via the connecting means connected to the memory slot.

According to an embodiment of the invention the device comprises memory and is adapted to store image data determined in the camera device from a memory card interface.

According to an embodiment of the invention the device is adapted to receive control commands from a mobile station and to read image data stored in a memory of the device as a response to the received control commands for reading said image data or controlling the camera to determine image data as a response to the control command for taking an image and the device is adapted to send said image data to the mobile station sent the control command.

The accessory device now developed can be connected with the invention to prior art cameras, which already store image data to a memory card, for transferring image data for remote reading. There is no need for any change with the cameras and the user only needs to find the accessory device now developed for enabling the remote reading.

### BRIEF DESCRIPTION OF THE FIGURES

Embodiments of the invention are now described in more details in connection with advantage embodiments of the invention by referring to enclosed figures, where:

FIG. 1 demonstrates a device according to an embodiment for remote reading images; and

FIG. 2 demonstrates an accessory device according to an embodiment in more details.

### DETAILED DESCRIPTION OF AN EMBODIMENT OF THE INVENTION

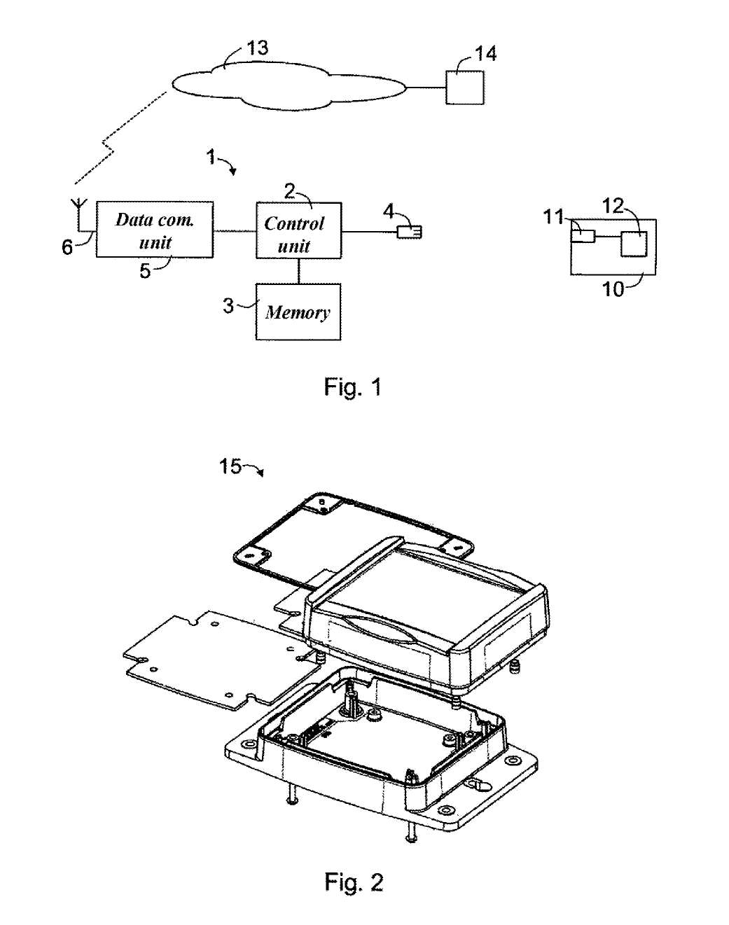

FIG. 1 demonstrates an arrangement according to an embodiment for remote reading images in a simplified mode. A special accessory device is demonstrated in FIG. 1, which is connected to a separate camera device 10 for reading image data taken by the camera device 10 by transferring images over a data communication network 13 to one or several remote devices 14. A structure of the camera device 10 is described in FIG. 1 only in parts essential for the invention. The camera device 10 may comprise means of the digital cameras known per se for determining digital image data, such as optical arrangements, image sensor arrangements, A/D-converter, processing algorithms for image data, etc. The camera device 10 comprises unit 12 for storing image data to a memory card connected to the camera device 10 via terminals 11 connected to a memory slot 11.

The accessory device 1 for enabling the remote reading of the camera device 10 comprises a control unit 2, memory 3, connecting means 4 and a data communication unit 5 coupled with an antenna.

The accessory device is provided with the connecting means 4, which can be called a memory card slot adapter, by which the accessory device 1 can be connected to the memory slot 11 of the camera device 10. The accessory means 1 is adapted to receive image data from the camera device via the memory card slot adapter 4 connected to the memory slot 11 and send image data wirelessly via the data communication unit 5. A significant advantage is obtained so that the accessory device 1 can be connected to the memory slot of the camera device 10 instead of an ordinary memory card without any special arrangement in the camera device 10. Also own power supply of the device can then be used and there is no need for an additional external power.

The control unit 2 can be a processing unit comprising one or more processes, where a computer program is executed, which comprises computer program code for controlling the accessory device 1. Especially a computer program like this or a computer program product comprising a computer program comprises code at least performing functions described next in the accessory device 1, at least to read image data gathered by the camera device 10 and to control the data communication unit 5 to transfer image data. The computer program may be stored in memory 3 or in external memory means, for example.

The control means 2 may be a separate unit implemented for sending image data, or it can be implemented at least partly by a processing unit controlling the functioning of the data communication unit, for example. The present functionally can be at least partly implemented by a special control electronic, which can be adapted to at least read image data gathered by the camera device 10 and control the data communication unit to transfer the image data.

According to an embodiment images taken by the camera device 10 are stored in the memory 3 of the accessory device 1 essentially immediately after determining the image data. In that case image data is stored via the memory card slot adapter 11 to the accessory device 1 now developed instead of an ordinary memory card so that there is no need for memory in the camera device 10. Image data can be stored to the internal memory of the accessory device 1 (e.g. hard disk or Flash memory) or to a memory unit connected to the accessory device 1.

According to an embodiment the memory card slot adapter 4 comprises a SD card format connector (Secure Digital) or a further version of it, such as mini-SD, micro-SD, SDHC (Secure Digital High Capacity), SDXC (Secure Digital Extended Capacity). The SD Group standard document is referred for more details of the SD memory card interface “SD Specifications, Part 1, Physical Layer Simplified Specification”, version 2.99, Sep. 25, 2006. In an embodiment the memory card slot adapter 4 is adapted to read the interface determined in this document. For example, the physical structures of the memory card slot adapter 4 are in line with the determination of this document. Also the control unit 2 of the accessory device or memory unit may be adapted to support at least portions of the functional determinations of said standard document, such as the SD bus protocol, whereupon image data can be stored to the internal memory of the accessory device 1 according to SD determinations.

It is to be noted that the present invention is not limited to the use of any special memory card type, but the accessory device 1 and its memory card slot adapter 4 can be adapted to support other memory card types, such as Compact Flash, Smartmedia, Memory Stick, PCMCIA-cards, MiniCard and SecureMMC. The accessory device 1 can also be provided with the memory card slot adapter 4 supporting more than one memory card type.

Referring again to FIG. 1, the accessory device 1 can be additionally comprise also other external connections as described in FIG. 1, for example for external memory. An identification module needed in functionality of the data communication unit 5 can also be connected to the accessory device, such as SIM card (Subscriber Identification Module).

According to an embodiment the data communication unit 5 comprises a transceiver. The data communication unit 5 can be adapted to support one or more data communication protocol suitable for communicating data. Some examples of the data communication techniques, at least part of which the data communication unit 5 can be adapted to use, are: GPRS (General Packer Radio Service), EDGE (Enhanced Data Rates for GSM Evolution) or other data communication techniques based on the second generation of the cellular data communication arrangement, data communication arrangement of the third generation, such as UMTS (Universal Mobile Telecommunications Systems), CDMA2000 or HSUPA (High Speed Uplink Packet Access9, HSDPA (High Speed Downlink Packet Access) or data communication techniques of telecommunication arrangement of fourth generation, such as LTE (Long Term Evolution).

It is to be noted that the implementation of the data communication unit 5 is not limited to use of some specific data communication arrangements, but also other present and future data communication techniques can be applied. It is also to be noted that the data communication unit 5 can support several data communication techniques, such as comprising GPRS and 3G modems.

No details of the data communication arrangement 13 are described because they depend on the used network technique and are not relevant for the invention. It is to be noted that the arrangement 13 can comprise several networks, such as a base station arrangement or mobile telecommunication network serving in the area of the accessory device 1, and connected to the Internet or to other telecommunication network.

FIG. 1 demonstrates generally a remote unit 14 to which image data can be transferred from the accessory device via data communication arrangement 1. The remote unit 14 can be for example a network server storing image data or a personal mobile station of the camera's owner connected to a mobile telecommunication network. The remote unit 14 by which the image data can be read with the accessory device 1, can also be another device, such as for example a computer connected to the Internet comprising a suitable software at least for receiving image data from the accessory device 1.

According to an embodiment the accessory device 1 is adapted to receive control commands from the remote unit 14 and send image data to the remote unit 14 as a response to the control command. The remote unit 14 and accessory device 1 have program implementing desired control functions. The control commands can be transferred by using data communication protocols know as such. According to an example the SMS service (Short Message Service) is used. The remote unit 14 can be adapted to create an SMS message, which comprises a control command in a text form and which is addressed to GSM IMSI identifier (International Mobile Subscriber Identity) of the remote unit 14. For example after finding the accessory device a software can be loaded to the remote unit 14 over the network or from a separate memory means, where the software implements an application for controlling the accessory device 1 and watching images stored to the camera 10.

The control command may be a command for sending stored image data, whereupon the accessory device 1 retrieves image data stored to its memory 3 or memory of the camera device 10 as a response to the control command like this. In that case images stored by the camera 10 can be read for example by a mobile station at a suitable moment without any need for travelling to the camera.

It is to be noted that the accessory device 1 may be adapted to send image data also to other device than the remote unit 14 sent the control command. The remote unit 14 may for example control the storing of images to a network server or external memory unit. According to an embodiment, software of the accessory device 1 comprises an email application and the accessory device 1 is adapted to send image data an email address determined beforehand or in the control command. The accessory device 1 may also be adapted to send images to a web based service, such as image delivering service.

The accessory device 1 and remote unit 14 may be adapted to support the control commands also for other purposes. The accessory device 1 can be controlled by the control command to send and/or control the camera device 10 to store image data at one or several moment(s) determined by the control command, such as at time intervals determined beforehand. The accessory device 10 can also be adapted to support an embodiment, where the number of images to be sent and/or stored is controlled by the control command. In addition an example of the control command to be applied is a determination of a destiny of image data, such as via a telephone number or email included in the control command.

According to another embodiment the accessory device 1 is adapted to control the camera 10 to determine image data as a response to the control command to take an image. In that case the camera 10 can be remote controlled by the remote unit 14 and gather an image from the environment of the camera immediately. Alternatively the camera 10 has an automatism which takes care of storing images in an appropriate way, such as a response to a control signal received from the motion sensor.

According to an embodiment the present accessory device 1 is an accessory connectable to the game cameras. Then the accessory device 1 is provided with a housing which is advantageously at least water proof and suitable for varying weather conditions. In FIG. 2 the housing of the accessory device 1 according to an embodiment is demonstrated in more details as an exploded view, where the different portions of the housing are separated from each other. The accessory device 1 can be encapsulated so that externally there is in visibly of the accessory device 1 only an antenna 6 and a wire for connecting to the memory slot 11 of the camera device 10. According to an embodiment of the invention the connecting means (4) are adapted to connect the accessory device 1 in a wireless way to the memory card slot 11 of the camera device 10. In this embodiment a unit, such as WLAN (Wireless Local Area Network) or Bluetooth-unit which is adapted to be structurally and functionally connectable to the memory card slot and enabling a wireless data communication is connected to the memory card slot. Also the accessory device 1 comprises a corresponding data communication unit, which is adapted to communicate with the data communication unit connected to the memory card slot and at least to receive image data. In this embodiment the accessory device 1 can be located more freely apart from the camera device 10.

It is to be noted that the present accessory device 1 can be applied to be used also for other types of cameras, and that the present ones are not limited to any specific application area. The present features can be applied for example for an access control arrangements. Then the accessory device can be connected for example to an access control camera installed in connection of an entry of home or a company, and image data can be delivered automatically to a control centre of a security company and/or mobile station when motion is detected.

It is obvious to a skilled person that the basic idea of the invention can be implemented in many ways when the technique is developed. Thus the invention and its embodiment are not limited to the examples described above but they can change in the spirit of the enclosed claims. Different features can thus be removed, modified or replaced by any equivalents and the features described in this application can be combined for creating different combinations.

1. A device for arranging a remote reading for a camera, wherein the device comprises data communication unit for transferring image data in a wireless way and connecting means for connecting the device to the camera, such as a game or monitoring camera and for transferring image data from the camera device to the data communication unit,
characterized in that
the connecting means are adapted to be connected to a memory slot of the camera device and the device is adapted to receive image data from the camera device via the connecting means connected to the memory slot.

2. The device of claim 1, characterized in that the device comprises memory and is adapted to store image data determined in the camera device from a memory card interface.

3. The device of claim 2, characterized in that the data communication unit comprises a receiver, and
the device is adapted to receive control commands from a mobile station and to read image data stored in a memory of the device as a response to the received control commands for reading said image data or controlling the camera to determine image data as a response to the control command for taking an image, and
the device is adapted to send said image data to the mobile station which sent the control command.

4. The device of claim 1, characterized in that the connecting means comprises a terminal to be connected to a Secure Digital SD memory slot.

5. The device of claim 1, characterized in that the device is adapted to receive a control command, which determines a destination of the image data, such as a telephone number or email address, and
the device is adapted to send image data received from the camera device to said destination determined by said received command.
